(19) United States
(12) Patent Application Publication
(10) Pub. No.: US 2008/0136807 A1
(43) Pub. Date: Jun. 12, 2008

(54) Plasma display device and driving method thereof

(76) Inventors: Young-Jun Jeon, Yongin-si (KR); JeongHoon Kim, Yongin-si (KR); Jungpil Park, Yongin-si (KR)

Correspondence Address: ROBERT E. BUSHNELL, 1522 K STREET NW, SUITE 300, WASHINGTON, DC, 20005-1202, US

(21) Appl. No.: 11/987,655

(22) Filed: Dec. 3, 2007

(30) Foreign Application Priority Data
Dec. 12, 2006 (KR) 10-2006-0126546

(51) Int. Cl. G06F 3/038

(52) U.S. Cl. 345/212

(57) ABSTRACT

A plasma display device and a driving method thereof reduce the number of power supplies by generating each of different levels of voltages from one power supply using a voltage converter. The plasma display device comprises: a plasma display panel formed with a plurality of electrodes including a scan electrode; and a scan electrode driver for applying to a scan electrode a scan signal including a ramp pulse applied for a reset period. The scan electrode driver comprises: a power supply for applying a first voltage; a first supplying part coupled between the power supply and the plasma display panel for applying a first voltage of the power supply to the scan electrode; and a second supplying part connected in parallel to the first supplying part for generating a second voltage using the first voltage, and for applying to the scan electrode a third voltage which is increased by as much as the second voltage on the basis of the first voltage.

### CLAIM FOR PRIORITY

This application makes reference to, incorporates the same herein, and claims all benefits accruing under 35 U.S.C.§119 from an application for PLASMA DISPLAY DEVICE AND DRIVING METHOD THEREOF earlier filed in the Korean Intellectual Property Office on the 12^{th} day of Dec. 2006 and there duly assigned Serial No. 10-2006-0126546.

### BACKGROUND OF THE INVENTION

1. Technical Field

The present invention relates to a plasma display device and a driving method thereof and, more particularly, to a plasma display device and a driving method thereof, which can reduce the number of power supplies by generating each of different levels of a voltage from one power supply using a voltage converter.

2. Related Art

A plasma display device is a flat display device for displaying a character or an image by using plasma generated by gas discharge. A plurality of row electrodes and a plurality of column electrodes are formed on a display panel of the plasma display device. In addition, a plurality of discharge cells is formed on a position where the row electrodes and the column electrodes intersect with each other. A gray level of an image is displayed by controlling the discharging state of the discharge cells.

Generally, the plasma display device divides one frame applied to the display panel into a plurality of sub-fields having a weight value, and realizes the gray level by controlling them through time division. Also, each sub-field is divided into a reset period, an address period, and a sustain period.

The reset period is a period for initializing each discharge cell so as to smoothly perform an address operation of the discharge cell, and the address period is a period for selecting a discharge cell that will be turned on among the discharge cells through an address discharge. The sustain period is a period for displaying a real image by discharging the discharge cell selected for the address period during a predetermined period

A related art plasma display device applies a rising ramp pulse to a scan electrode for a rising interval of a reset period so as to form a wall charge for the address discharge that will be generated for the address period. To generate the rising ramp pulse, a separate power supply Vₛₑₜ, in addition to a power supply Vₛ, is needed.

However, because both the power supply Vₛ and the separate power supply Vₛₑₜ are high-priced, there is a problem in that the entire manufacturing cost of the plasma display device is increased. Also, when the power supply Vₛ is varied, there is a problem in that the power supply Vₛₑₜ should be changed in order to form the same wall charge as an existing wall charge for the address period.

### SUMMARY OF THE INVENTION

Accordingly, the present invention has been developed to solve the above-mentioned problems occurring in the related art, and an object of the present invention is to provide a plasma display device and a driving method thereof which can reduce the number of power supplies by generating each of different levels of voltage from one power supply using a voltage converter.

Additional advantages, objects and features of the invention will be set forth in part in the description which follows, and in part will become apparent to those having ordinary skill in the art upon examination of the following, or may be learned from practice of the invention

According to an aspect of the present invention, a plasma display device comprises: a plasma display panel formed from a plurality of electrodes including a scan electrode; and a scan electrode driver for applying a scan signal, including a ramp pulse applied for a reset period, to a scan electrode.

The scan electrode driver may include: a power supply for applying a first voltage; a first supplying part which is coupled between the power supply and the plasma display panel, and which applies a first voltage of the power supply to the scan electrode; and a second supplying part connected in parallel to the first supplying part for generating a second voltage using the first voltage, and for applying to the scan electrode a third voltage which is increased by as much as the second voltage on the basis of the first voltage.

The first supplying part may include a first switch coupled to the power supply and a second switch coupled between the first switch and the scan electrode.

The second supplying part may include: a voltage converter which is coupled between the power supply and the scan electrode to generate the second voltage; a third switch which is coupled between the voltage converter and the scan electrode to apply the third voltage to the scan electrode; a capacitor having one terminal coupled between the voltage converter and the third switch, and another terminal coupled between the first switch and the second switch; and a ramp generator which is connected to the third switch to generate a rising ramp pulse which is applied for a rising interval of the reset period.

The first voltage and the second voltage may be a voltage of positive polarity, and the second voltage may be a voltage which is dropped by a variable voltage of the voltage converter from the first voltage.

The voltage converter may include a transistor having a first terminal coupled to the power supply and a second terminal coupled to the third switch; a first resistor having a first terminal coupled to the power supply and a second terminal coupled to a third terminal of the transistor; and a second resistor having a first terminal coupled to the third terminal of the transistor and a second terminal coupled to the third switch.

The variable voltage may be controlled by the first resistor and the second resistor so as to generate the second voltage which is dropped by the variable voltage in the first voltage.

The first and second resistors may be fixed resistors.

At least one of the first and second resistors may be a variable resistor.

The transistor may be a Bipolar Junction Transistor (BJT), a Metal Oxide Silicon Field Effect Transistor (MOSFET), or an Insulated Gate Bipolar Transistor (IGBT).

The plasma display device may further include: an address electrode driver for applying a display data signal to the address electrode; and a sustain electrode driver for applying the sustain pulse to the sustain electrode; wherein the plasma display panel includes an address electrode and a sustain electrode.

According to another aspect of the present invention, a driving method of a plasma display device is provided. The plasma display device includes: a plasma display panel having a plurality of scan electrodes for applying a ramp pulse for a reset period, a plurality of sustain electrodes, and a plurality of address electrodes; and a scan electrode driver including a power supply, a first supplying part, and a second supplying part for applying a scan signal, including a ramp pulse, to the scan electrode. The driving method includes: (a) generating a second voltage from the second supplying part using a first voltage of the power supply; (b) charging the second voltage to the second supplying part; (c) applying the first voltage to the scan electrode; and (d) applying to the scan electrode a third voltage which is increased by the second voltage from the first voltage.

In step (a), the second voltage, which is dropped by a variable voltage obtained by a voltage converter coupled between the power supply and the scan electrode from the first voltage, is generated.

In step (b), the second voltage may be charged at one terminal of a capacitor coupled between the voltage converter and the scan electrode.

Step (c) may include: applying the first voltage to the scan electrode by turning on a first switch coupled to the power supply and a second switch coupled between the first switch and the scan electrode; and charging an electric potential of the other terminal of the capacitor coupled between the first switch and the second switch with a third voltage which adds the first voltage to the second voltage by turning the second switch off.

In step (d), the third voltage is applied to the scan electrode by turning on the third switch coupled between the second voltage converter and the scan electrode in a state wherein the second switch is turned off.

A rising ramp pulse having a slope for a rising period of the reset period by a ramp generating part connected to the third switch may be applied to the scan electrode.

The variable voltage may be obtained by controlling the first and second resistors of the voltage converter, including a transistor having a first terminal coupled to the power supply and a second terminal coupled to the third switch, a first resistor having a first terminal coupled to the power supply and a second terminal coupled to a third terminal of the transistor, and a second resistor having a first terminal coupled to the third terminal of the transistor and a second terminal coupled to the third switch.

The driving method of the plasma display device may include applying a display data signal from the address driver to the address electrode, and applying a sustain pulse from the sustain electrode driver to the sustain electrode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic block diagram illustrating a plasma display device according to one exemplary embodiment of the present invention.

FIG. 2 is a waveform diagram illustrating a driving waveform for driving the plasma display device of FIG. 1.

FIG. 3 is a circuit diagram illustrating a part of a driver of a plurality of Y electrodes for realizing a rising ramp pulse which is applied to the Y electrodes during the reset period of FIG. 2.

FIG. 4 is a circuit diagram illustrating a voltage converter of the plasma display device according to another exemplary embodiment of the present invention.

FIG. 5 is a circuit diagram illustrating another constitution of the voltage converter shown in FIG. 4.

FIG. 6 is a circuit diagram illustrating still another constitution of the voltage converter of FIG. 4.

FIGS. 7a to 7c illustrate operation processes for realizing a rising ramp pulse applied to the scan electrode during a rising interval of the reset period among driving waveforms of FIG. 2.

### DETAILED DESCRIPTION OF THE INVENTION

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. The matters defined in the description, such as the detailed construction and elements, are nothing but specific details provided for assisting those of ordinary skill in the art in obtaining a comprehensive understanding of the invention, and the present invention is only defined within the scope of the appended claims. In the entire description of the present invention, the same drawing reference numerals are used for the same elements throughout the various figures.

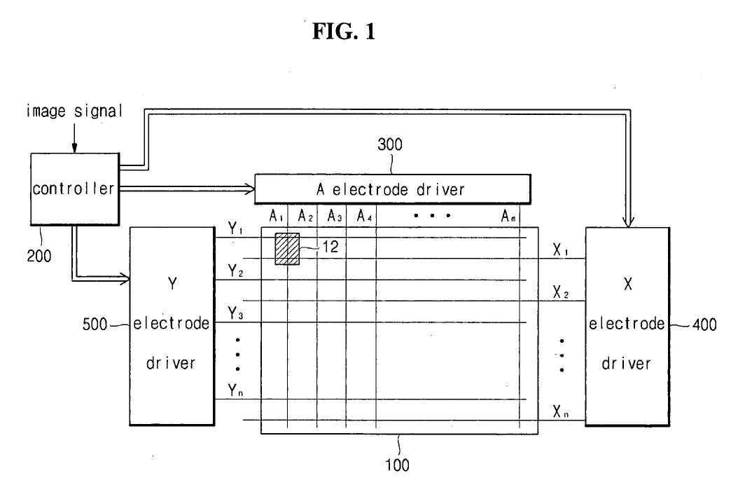

FIG. 1 is a schematic block diagram illustrating a plasma display device according to one exemplary embodiment of the present invention.

Referring FIG. 1, the plasma display device includes a plasma display panel 100, a controller 200, an address electrode driver 300, a sustain electrode driver 400, and a scan electrode driver 500.

The plasma display panel 100 includes a plurality of address electrodes that extend in a column direction (A₁˜Aₘ) (hereinafter, referred to as “A electrode”), a plurality of sustain electrodes (X₁˜Xₙ) (hereinafter, referred to as “X electrode”) and a plurality of scan electrodes (Y₁˜Yₙ) (hereinafter, referred to as “Y electrode”) that extend in a row direction with them to make a pair. Generally, the X electrodes (X₁˜Xₙ) are formed in correspondence to Y electrodes (Y₁˜Yₙ), so as to display an image for a sustain period. The Y electrodes (Y₁˜Yₙ) and X electrodes (X₁˜Xₙ) are orthogonally arranged relative to the A electrodes (A₁˜Aₘ).

In this case, a discharge space, which is positioned at a crossing point of A electrode (A₁˜Aₘ), X electrode (X₁˜Xₙ) and Y electrode (Y₁˜Yₙ), forms a cell 12. This structure of the plasma display panel 100 is merely one exemplary embodiment. Accordingly, a panel of another structure, where a driving waveform can be applied, can be also applied to the present invention.

The controller 200 receives an image signal from the outside and outputs a driving control signal of the A electrode, a driving control signal of the X electrode, and a driving control signal of the Y electrode. The controller 200 is driven by dividing one frame into a plurality of sub-fields, each sub-field including a reset period, an address, and a sustain period according to operation change of time.

The A electrode driver 300 receives the driving control signal of the A electrode from the controller 200, and applies to each A electrode a display data signal for selecting a discharge cell to be displayed.

The X electrode driver 400 receives the driving control signal of the X electrode from the controller 200, and applies the driving voltage to the X electrode.

The Y electrode driver 500 receives the driving control signal of the Y electrode from the controller 200, and applies a driving voltage to the Y electrode.

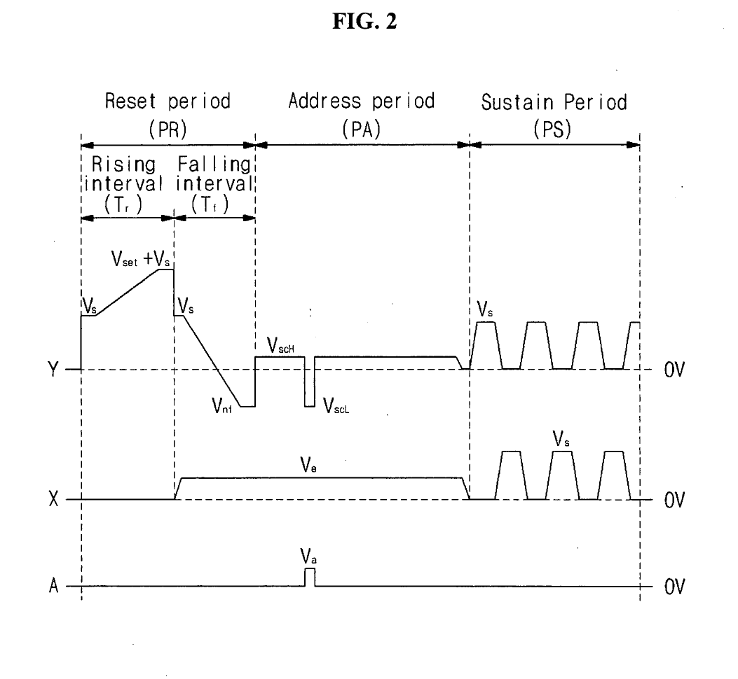

FIG. 2 is a waveform diagram illustrating a driving waveform for driving the plasma display device of FIG. 1.

Referring to FIG. 2, the driving waveform of one of a plurality of sub-fields, which forms one frame, is shown. For convenience in explanation, the driving waveforms, which are applied to the Y electrodes, the X electrodes, and the A electrodes that form a cell, will be explained below.

As shown in FIG. 2, in the driving waveform for driving the plasma display panel 100 of the plasma display device, a reset period (PR) of one sub-field includes a rising interval (Tr) and a falling interval (T_{f}).

In the rising interval (Tr) of the reset period (PR), a voltage of a rising ramp pulse waveform is applied to the Y electrodes (Y₁˜Yₙ). The voltage of the rising ramp pulse waveform is continuously increased from a first voltage (Vₛ) (e.g., 200 volts) to a third voltage (Vₛ+Vₛₑₜ) (e.g., 395 volts) which is higher by as much as the second voltage (Vset) which is less than the first voltage (Vₛ). In this time, a ground voltage (0V in FIG. 2) is applied to X electrodes (X₁˜Xₙ) and address electrodes (A₁˜Aₘ). Accordingly, a weak discharge occurs between Y electrodes (Y₁˜Yₙ) and X electrodes (X₁˜Xₙ) and, on the other hand, a weaker discharge occurs between Y electrodes (Y₁˜Yₙ) and address electrodes (A₁˜Aₘ). According to the weak discharge, negative (−) wall charge is formed on the Y electrode and positive (+) wall charge is formed on the X electrode and the A electrode. In the case where a voltage of the Y electrode is gradually changed as shown in FIG. 2, the wall charge is formed so as to enable the sum of a voltage applied from the outside and the wall voltage of the cell by generating the weak discharge to maintain a state of the firing voltage. In the reset period, since the state of all cells is initialized, the third voltage (Vₛ+Vₛₑₜ) should be a high voltage by as much as discharge of all cells occurs. Also, the first voltage (Vₛ) is usually the highest voltage among the voltages applied to the Y electrode for the sustain period, but it is a voltage less than the firing voltage between the Y electrode and X electrodes.

Next, in a falling interval (T_{f}), when a voltage applied to the X electrodes (X₁˜Xₙ) maintains a fourth voltage (Vₑ), a voltage of the falling ramp waveform is applied to the Y electrodes (Y₁˜Yₙ). The voltage of the falling ramp waveform drops from the first voltage (Vₛ) to a fifth voltage (V_{nf}) (for example, −200V). In this time, a ground voltage (0V) is maintained at the A electrodes (A₁˜Aₘ). Then, a weak discharge occurs between the Y electrodes and X electrodes, and between Y electrodes and the A electrodes, while the voltage of the Y electrodes is decreased, and simultaneously negative (−) wall charge formed on the Y electrodes and positive (+) charge formed on the X electrode and the A electrode are erased. Generally, an absolute value of the fifth voltage (V_{nf}) minus the fourth level voltage (Vₑ) is set near the firing voltage between the Y electrode and X electrode. Then, the wall voltage between the Y electrode and X electrode becomes 0V, thereby preventing a misfiring so that the discharge cell, which has not been discharged for the address period, is discharged for the sustain period.

Then, in the address period (PA), the display data signal of the address pulse is applied to the address electrodes, and a scanning signal of the scan pulse of a scan low voltage (VscL) (for example, −200 volts) is sequentially applied to the Y electrodes (Y₁˜Yₙ), which scanning signal is biased as a scan high voltage (V_{scH}) less than the first voltage (Vₛ) (for example, 120V), thereby performing smooth addressing. Herein, in order that the scan low voltage (V_{scL}) have a value lower than the fifth voltage (V_{nf}), the fifth voltage (V_{nf}) can be set at about −188V, and the scan low voltage can be set at about −200V.

In this time, in the case where the display data signal applied to each address electrode (A₁˜Aₘ) selects a discharge cell, the address voltage (Vₐ) of positive polarity is applied and, otherwise, the ground voltage (0V) is applied. Accordingly, if the display data signal of the address voltage (Vₐ) having positive polarity is applied while the scan pulse of the fifth voltage (V_{nf}) is applied, wall charges are formed by the address discharge in a corresponding discharge cell, and otherwise, wall charges are not formed in the other discharge cell. Also, for more accurate and effective address discharge, the fourth voltage (Vₑ) is applied to X electrodes (X₁˜Xₙ).

Then, in the sustain period (PS), the sustain pulse of the first voltage (Vₛ) is alternately applied to all Y electrodes (Y₁˜Yₙ) and X electrodes (X₁˜Xₙ) and, in a corresponding address period (PA), the sustain discharge occurs in discharge cells formed by wall charges.

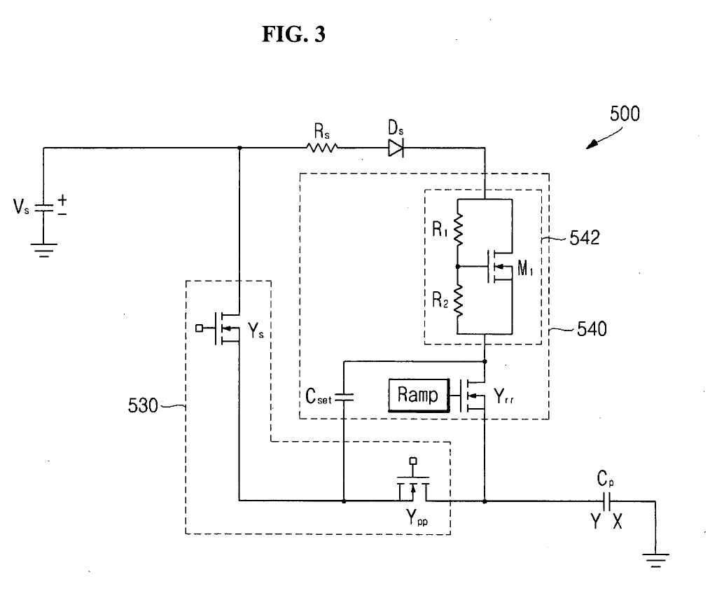

FIG. 3 is a circuit diagram illustrating a part of a Y electrode driver for realizing a rising ramp pulse applied to a plurality of Y electrodes for the reset period of FIG. 2.

Referring to FIG. 3, a capacitive component formed by the Y electrode near an X electrode is illustrated as a panel capacitor (Cₚ), and the X electrode of the panel capacitor (Cₚ) is biased by a ground voltage. A switching element used below is illustrated by an n channel transistor. The switching element may be a Field Effect Transistor (FET) having a body diode and also another switching element for performing the same or similar function.

The Y electrode driver 500 includes a power supply Vₛ, a first supplying part 530, a second supplying part 540 having a voltage converter 542, a diode (Dₛ) for preventing a reverse current, and a resistor (Rs) for preventing an in-rush current.

The power supply Vₛ is a voltage which supplies the first voltage (Vₛ). The power supply Vₛ applies the first voltage (Vₛ) to the Y electrode in order to generate a pulse for a reset discharge, and a sustain discharge during a reset period and a sustain period among driving waveforms in FIG. 2. Also, the power supply Vₛ applies the first voltage (Vₛ) to the X electrode in order to generate a pulse for performing the sustain discharge for the sustain period.

The first supplying part 530 is coupled between a Vₛ power supply and a Y electrode to supply the first voltage (Vₛ) generated by the power supply Vₛ to the Y electrode. The first supplying part 530 includes the first switch (Yₛ) connected to the power supply Vₛ, and the second switch (Yₚₚ) coupled between the first switch (Yₛ) and the Y electrode. Accordingly, when the first switch (Ys) and the second switch (Yₚₚ) are turned on, the first voltage (Vₛ) of the power supply Vₛ is applied to the Y electrode for a rising interval (Tᵣ) of a reset period (PR).

The second supplying part 540 is coupled in parallel with the first supplying part 530, and includes a voltage converter 542, a third switch (Yᵣᵣ), a capacitor (Cₛₑₜ), and a ramp generator (ramp).

The voltage converter 542 is coupled with the Vₛ power supply and the Y electrode, and generates the second voltage (Vₛₑₜ) by using the first voltage (Vₛ) of the power supply Vₛ. Herein, the first voltage (Vₛ) has a positive polarity and the second voltage (Vₛₑₜ) has a positive polarity less than that of the first voltage (Vₛ).

The second voltage (Vₛₑₜ) is a voltage (Vₛ−ΔV) which is obtained by being dropped by a variable voltage (ΔV) of the voltage converter 542 in the first voltage (Vₛ). The second voltage (Vₛₑₜ) is applied to the Y electrode by being added to the first voltage (Vₛ) to realize a rising ramp pulse for a rising interval of a reset period of a driving waveform, and is a voltage for forming a wall charge suitable for address discharge generated for the following address period.

Similarly, the plasma display device according to the present invention can remove the power supply Vₛₑₜ by generating each of different levels of voltages (Vₛ, Vₛₑₜ) from one power supply Vₛ using the voltage converter 542, differently from the existing plasma display device in which at least two power supplies, namely, the power supply Vₛ and power supply Vₛₑₜ, are needed for realizing the rising ramp pulse. Accordingly, the plasma display device according to the present invention can reduce the entire manufacturing cost by removing the high-price power supply Vₛₑₜ.

The third switch (Yᵣᵣ) is coupled between the voltage converter 542 and the Y electrode, the capacitor (Cₛₑₜ) is connected in parallel with the third switch (Yᵣᵣ), and the ramp generator (ramp) is connected to the third switch (Yᵣᵣ). More particularly, the first terminal of the third switch (Yᵣᵣ) is coupled to the voltage converter 542, the second terminal is coupled between the second switch (Yₚₚ) and the Y electrode, and the third terminal is coupled to the ramp generator (ramp). One terminal of the capacitor (Cₛₑₜ) is coupled between the voltage converter 542 and the third switch (Yᵣᵣ), and the other terminal of the capacitor (Cₛₑₜ) is coupled between the first switch (Yₛ) and the second switch (Yₚₚ). Herein, the first terminal of the third switch (Yᵣᵣ) is a drain terminal, the second terminal is a source terminal, and the third terminal is a gate terminal.

The second supplying part 540 increases the second voltage (Vₛₑₜ) generated by using the voltage converter 542 to the third voltage (Vₛ+Vₛₑₜ) through the capacitor (Cₛₑₜ), and applies the third voltage (Vₛ+Vₛₑₜ), which is increased when the third switch (Yᵣᵣ) is turned on, to the Y electrode through the third switch (Yᵣᵣ) connected to the ramp generator (ramp), thereby generating the rising ramp pulse for the rising interval of the reset period in order to form the wall charge, which is suitable for the address discharge.

Meanwhile, the diode (Dₛ) for preventing a reverse current prevents the current from flowing to the power supply Vₛ and the resistor (Rₛ) for preventing an in-rush current prevents the current from flowing instantly from the power supply Vₛ.

Next, the inner structure of the voltage converter 542, which generates the second voltage (Vₛₑₜ) by being dropped by variable voltage (ΔV) from the first voltage (Vₛ) supplied from the power supply Vₛ, will be explained in more detail.

As shown in FIG. 3, the voltage converter 542 of the plasma display device according to one exemplary embodiment of the present invention includes a transistor (M₁), first resistor (R₁) and second resistor (R₂).

The first terminal of the transistor (M₁) is coupled to the power supply Vₛ, the second terminal is coupled to the third switch (Yᵣᵣ), and the third terminal is coupled to a path in which the first resistor (R₁) and the second resistor (R₂) are serially connected. Herein, the transistor (M₁) uses a Metal Oxide Silicon Field Effect Transistor (MOSFET), but may imply a switch like a BJT (Bipolar Junction Transistor) or a IGBT (Insulated Gate Bipolar Transistor). The first terminal of the transistor (M₁) is a drain terminal, the second terminal is a source terminal, and the third terminal is a gate terminal.

The first terminal of the first resistor (R₁) is coupled to the power supply Vₛ and the second terminal is the first resistor (R₁) coupled to the third terminal of the transistor (M₁).

The first terminal of the second resistor (R₂) is coupled to the third terminal of the transistor (M₁); and the second terminal of the second resistor (R₂) is coupled to the third switch (Yᵣᵣ).

In this manner, the voltage converter 542 generates the variable voltage (ΔV) which is dropped from the first voltage (Vₛ) in order to output the second voltage (Vₛₑₜ) to the first terminal of the third switch (Yᵣᵣ).

The variable voltage (ΔV) can be obtained by Equation 1 which shows a relationship between a gate-source voltage (V_{gs}), the first resistor (R₁), and the second resistor (R₂).

$$Δ V = Vgs ( 1 + \frac{{R}_{1}}{{R}_{2}} ) \qquad [ Equation 1 ]$$

wherein the gate-source voltage (V_{gs}) of the transistor (M₁) is a threshold voltage and can be changed according to the type of transistor. The variable voltage (ΔV) may be set by controlling the ratio of the first resistor (R₁) and the second resistor (R₂). Accordingly, by setting up the variable voltage (ΔV), a desired second voltage (Vₛₑₜ) can be generated from the first voltage (Vₛ). In this way, the first resistor (R₁) and the second resistor (R2) are a fixed resistor, and can be changed for setting up the desired variable voltage (ΔV). Therefore, the first voltage (Vₛ) and the second voltage (Vₛₑₜ) for realizing the rising ramp pulse for the rising interval of the reset period can be generated by one power supply Vₛ and applied to the Y electrode. Herein, a high voltage (Vₛ, Vₛₑₜ) is applied to the Y electrode during the rising interval of the reset period, thereby allowing elements for realizing the rising ramp pulse for the rising interval to be influenced by temperature. Accordingly, the voltage converter 542 comprises resistors and a transistor having small influence according to temperature change, thereby reducing fluctuation of output voltage when a voltage, which realizes the rising ramp pulse that is applied for the rising interval of the reset period, is outputted.

Referring FIG. 3, the transistor (M₁) is a MOSFET, but in the case where the transistor (M₁) is a BJT (Bipolar Junction Transistor) or an IGBT (Insulated Gate Bipolar Transistor), a desired variable voltage (ΔV) can be realized by inserting the voltage V_{be} or V_{ge}, instead of the voltage V_{gs}, in Equation 1.

As described above, the plasma display device according to one exemplary embodiment of the present invention can generate each of different levels of voltage from one power supply by using the voltage converter including the resistor.

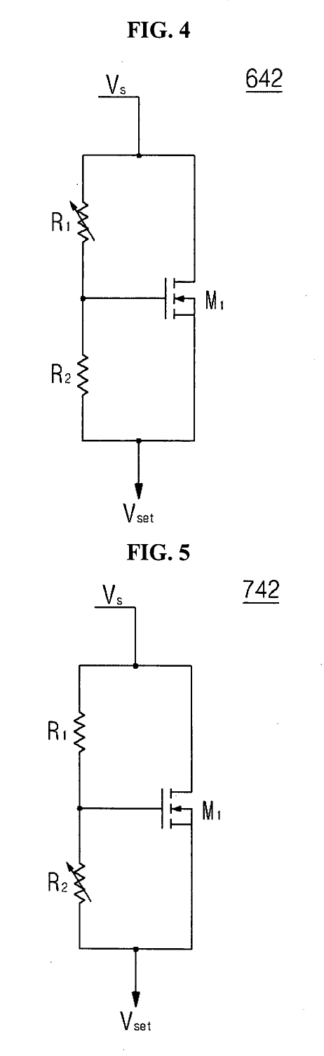

FIG. 4 is a circuit diagram illustrating a voltage converter of the plasma display device according to another exemplary embodiment of the present invention.

The operation of the voltage converter 642 of FIG. 4 is the same as that of the voltage converter 542 of FIG. 3, except that at least one of the first resistor (R₁) and the second resistor (R₂) is a variable resistor. Therefore, the explanation of the same part as the voltage converter 524 of FIG. 3 will be omitted.

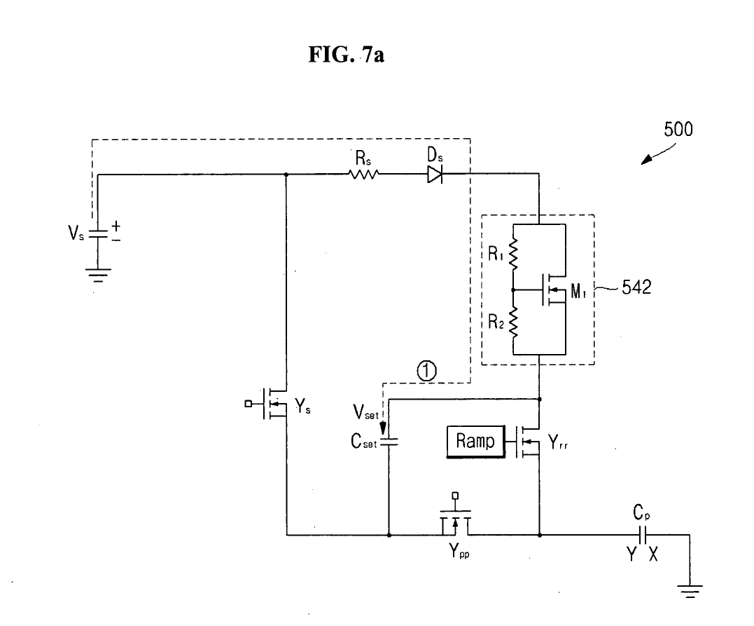

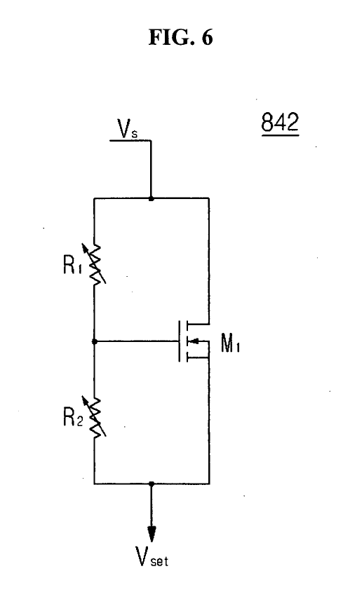

The voltage converter 642 of FIG. 4 includes a transistor (M₁), a first resistor (R₁) and a second resistor (R₂). The first resistor (R₁) is a variable resistor and the second resistor (R₂) is a fixed resistor. Also, as shown in FIG. 5, another type voltage converter 742 can include the first resistor (R₁) which is a fixed resistor and the second resistor (R₂) which is a variable resistor. Also, as shown in FIG. 6, another type voltage converter 842 can include the first resistor (R₁) and the second resistor (R₂), those being variable resistors.

Each of the voltage converters 642, 742, and 842, according to another exemplary embodiment of the present invention, also realizes the variable voltage (ΔV) which is dropped from the first voltage (Vₛ) in order to output the second voltage (Vₛₑₜ) to the first terminal of the third switch (Yᵣᵣ), using Equation 1.

Each of the voltage converters 642, 742 and 842 can generate the desired variable voltage (ΔV) by predetermining the transistor (M₁) and selectively controlling at least one of the first and second resistors (R₁, R₂), wherein, at least one of the first and second resistors (R₁, R₂) is a variable resistor. For example, the voltage converter 642 shown in FIG. 4 obtains the variable voltage (ΔV) by controlling the first resistor (R₁) which is a variable resistor, thereby reducing processes which separately replace both the first resistor (R₁) and the second resistor (R₂) according to the desired variable voltage (ΔV) in the voltage converter 542, and reducing its cost.

The transistor (M₁) is a MOSFET in each of the voltage converters 642, 742 and 842, but even when the transistor (M₁) is a BJT (Bipolar Junction Transistor) or IGBT (Insulated Gate Bipolor Transistor), the desired variable voltage (ΔV) can be realized by applying the voltages (V_{be} or V_{ge}) instead of the voltage V_{gs} in Equation 1.

As describe above, the plasma display device according to another exemplary embodiment of the present invention can generate each of different levels of voltage from one power supply using the voltage converter having at least one variable resistor. Furthermore, the plasma display device according to another exemplary embodiment of the present invention realizes the desired variable voltage by controlling at least one variable resistor of the voltage converter, thereby preventing resistors from being replaced according to the desired variable voltage, even when all resistors included in the voltage converter of the plasma display device are fixed resistors.

As described above, the plasma display device according to the present invention is equipped with the voltage converter, thereby allowing one power supply Vₛ to apply each of different levels of the voltage (Vₛ, Vₛₑₜ) to the Y electrode for the rising interval of the reset period. Therefore, the plasma display device according to the present invention can reduce the manufacturing cost of the power supply as compared with the case in which the related art plasma display device includes a separate Vₛₑₜ power supply and a power supply Vₛ for applying each of different levels of the voltage (Vₛ, Vₛₑₜ) to the Y electrode in order to generate the rising ramp pulse in the rising interval of the reset period.

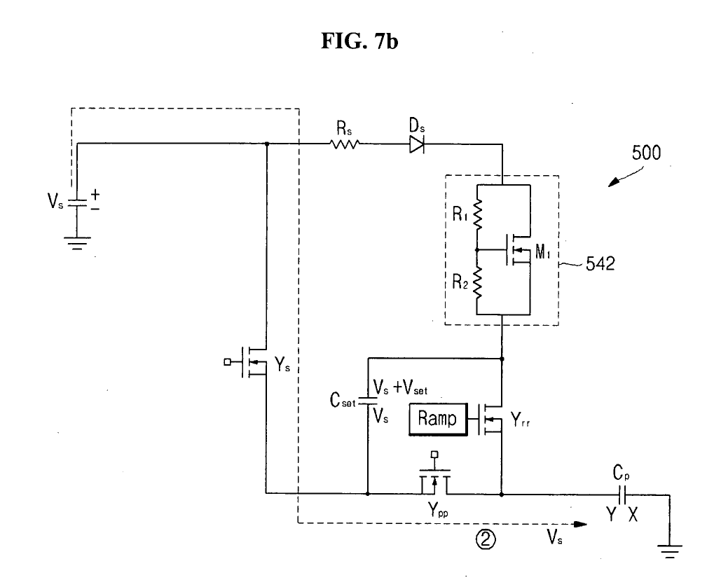

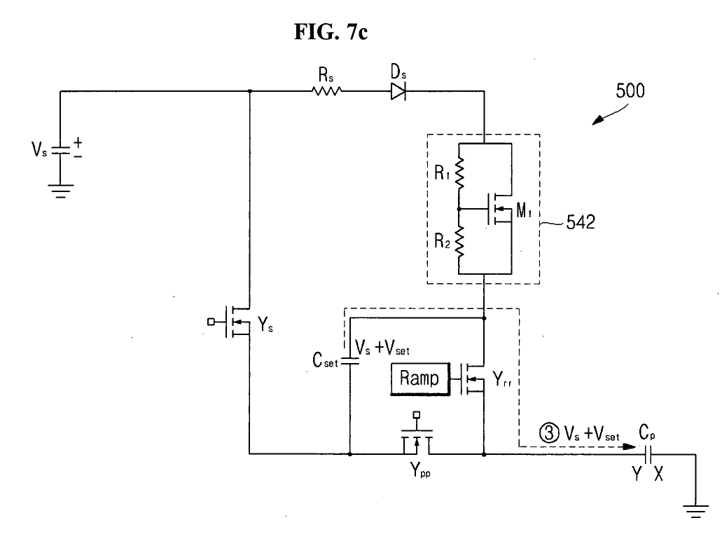

FIGS. 7a to 7c show operation processes for realizing a rising ramp pulse applied to the scan electrode during a rising interval of the reset period among driving waveforms of FIG. 2.

The driving method of the plasma display device according to one exemplary embodiment of the present invention includes a first step S1 which generates the second voltage (Vₛₑₜ) from the first voltage (Vₛ) which is supplied from the power supply Vₛ, a second step S2 which charges the second voltage (Vₛₑₜ) to the second supplying part 540, a third step S3 which applies the first voltage (Vₛ) to the Y electrode, and a fourth step S4 which applies to the Y electrode the third voltage (Vₛ+Vₛₑₜ) increased by as much as the second voltage (Vₛₑₜ) on the basis of the first voltage (Vₛ).

Firstly, referring to FIG. 7a, in the first step S1, before turning the first switch (Ys) on, the first voltage (Vₛ), which is applied through the resistor (Rs) for preventing the in-rush current and the diode (Dₛ) for preventing the reverse current from Vₛ power supply, is dropped by the variable voltage (ΔV) obtained by the voltage converter 542, so that the second voltage (Vₛₑₜ) is generated. In the second step S2, the generated second voltage (Vₛₑₜ) is charged to one terminal of capacitor (Cₛₑₜ) coupled to the voltage converter 542 and the third switch (Yᵣᵣ) (\textcircled{1}).

Referring to FIG. 7b, in the third step S3, when the first switch (Yₛ) and the second switch (Yₚₚ) are turned on, the first voltage (Vₛ) from Vₛ power supply is applied to the Y electrode through the first switch (Yₛ) and the second switch (Yₚₚ) (\textcircled{2}). When the second switch (Yₚₚ) is turned off, an electric potential on the source terminal of the second switch (Yₚₚ) becomes the first voltage (Vₛ), and the electric potential on the other terminal of the capacitor (Cₛₑₜ), which is coupled to the source terminal of the second switch (Yₚₚ), becomes the first voltage (Vₛ). Accordingly, the electric potential of one terminal of the capacitor (Cₛₑₜ) becomes the third voltage (Vₛ+Vₛₑₜ) which adds the first voltage (Vₛ) to the second voltage (Vₛₑₜ).

Next, referring to FIG. 7c, in the fourth step S4, when the third switch (Yᵣᵣ) is turned on in a state in which the second switch (Yₚₚ) is turned off, the third voltage (Vₛ+Vₛₑₜ) is applied to the Y electrode (\textcircled{3}). The third voltage (Vₛ+Vₛₑₜ) is the electric potential of the first terminal on the third switch (Yᵣᵣ) which is coupled to one terminal of the capacitor (Cₛₑₜ). In this time, the rising ramp pulse having a slope determined by the ramp generator (ramp), which is connected to the third switch (Yᵣᵣ) is applied to the Y electrode.

As described above, the driving method of the plasma display device of the present invention can realize the rising ramp pulse by applying each of different levels of voltage (Vₛ, Vₛₑₜ) to the Y electrode during the rising interval of the reset period from one power supply Vₛ by using a voltage converter. Therefore, it can reduce the manufacturing cost as compared to the case in which a driving method of the related art plasma display device uses separate power supply Vₛₑₜ as well as the power supply Vₛ for applying each of different levels of voltage (Vₛ, Vₛₑₜ) to the Y electrode during the rising interval of the reset period.

As described above, the plasma display device and the driving method according to the present invention produce the following effects.

First, each of different levels of voltage is generated from one power supply using the voltage converter, thereby allowing the number and the manufacturing cost for the power supply to be reduced.

Second, even if the first voltage of the power supply Vₛ is varied, the desired second voltage can be generated by adjusting the variable voltage of the voltage converter, thereby allowing the same wall charge as those formed for the address period in the related art plasma display device to be formed.

The foregoing exemplary embodiments and aspects of the invention are merely exemplary, and are not to be construed as limiting the present invention. The present teaching can be readily applied to other types of devices. Also, the description of the exemplary embodiments of the present invention is intended to be illustrative, and not to limit the scope of the claims, and many alternatives, modifications and variations will be apparent to those skilled in the art.

What is claimed is:

1. A plasma display device, comprising:
a plasma display panel formed with a plurality of electrodes including a scan electrode; and
a scan electrode driver for applying a scan signal including a ramp pulse applied for a reset period to a scan electrode;
wherein the scan electrode driver comprises:
a power supply for applying a first voltage;
a first supplying part which is coupled between the power supply and the plasma display panel, and which applies a first voltage of the power supply to the scan electrode; and
a second supplying part which is connected in parallel to the first supplying part for generating a second voltage using the first voltage, and for applying to the scan electrode a third voltage which is increased by as much as the second voltage on the basis of the first voltage.

2. The plasma display device of claim 1, wherein the first supplying part comprises a first switch coupled between the power supply, and a second switch coupled between the first switch and the scan electrode.

3. The plasma display device of claim 2, wherein the second supplying part comprises:
a voltage converter which is coupled between the power supply and the scan electrode to generate the second voltage;
a third switch which is coupled between the voltage converter and the scan electrode to apply the third voltage to the scan electrode;
a capacitor having one terminal coupled between the voltage converter and the third switch, and another terminal coupled between the first switch and the second switch; and
a ramp generator which is connected to the third switch to generate a rising ramp pulse which is applied for a rising interval of a reset period.

4. The plasma display device of claim 3, wherein the first voltage and the second voltage respectively are voltages of positive polarity, and the second voltage is a voltage which is dropped from the first voltage by a variable voltage of the voltage converter.

5. The plasma display device of claim 4, wherein the voltage converter comprises:
a transistor having a first terminal coupled to the power supply and a second terminal coupled to the third switch;
a first resistor having a first terminal coupled to the power supply and a second terminal coupled to a third terminal of the transistor; and
a second resistor having a first terminal coupled to the third terminal of the transistor and a second terminal coupled to the third switch.

6. The plasma display device of claim 5, wherein the variable voltage is controlled by the first resistor and the second resistor so as to generate the second voltage which is dropped from the first voltage by the variable voltage.

7. The plasma display device of claim 5, wherein the first and second resistors are fixed resistors.

8. The plasma display device of claim 5, wherein at least one of the first and second resistors is a variable resistor.

9. The plasma display device of claim 5, wherein the transistor is one of a Bipolar Junction Transistor (BJT), a Metal Oxide Silicon Field Effect Transistor (MOSFET), and an Insulated Gate Bipolar Transistor (IGBT).

10. The plasma display device of claim 1, further comprising:
an address electrode driver for applying a display data signal to the address electrode; and
a sustain electrode driver for applying the sustain pulse to the sustain electrode;
wherein the plasma display panel includes an address electrode and a sustain electrode.

11. A driving method of a plasma display device which includes a plasma display panel having a plurality of sustain electrodes, a plurality of address electrodes and a plurality of scan electrodes for applying a ramp pulse for a reset period, and a scan electrode driver including a power supply, a first supplying part, and a second supplying part for applying a scan signal including a ramp pulse to the scan electrode, said method comprising the steps of:
(a) generating a second voltage from the second supplying part using a first voltage of the power supply;
(b) charging the second voltage to the second supplying part;
(c) applying the first voltage to the scan electrode; and
(d) applying a third voltage, which is increased by the second voltage from the first voltage, to the scan electrode.

12. The driving method of claim 11, wherein, in step (a), the second voltage, which is dropped by a variable voltage obtained by a voltage converter coupled between the power supply and the scan electrode from the first voltage, is generated.

13. The driving method of claim 12, wherein, in step (b), the second voltage is charged at one terminal of a capacitor coupled between the voltage converter and the scan electrode.

14. The driving method of claim 13, wherein step (c) further comprises:
applying the first voltage to the scan electrode by turning on a first switch coupled to the power supply and a second switch coupled between the first switch and the scan electrode; and
charging an electric potential of another terminal of the capacitor coupled between the first switch and the second switch with the third voltage, which adds the first voltage to the second voltage, by turning the second switch off.

15. The driving method of claim 14, wherein, in step (d), the third voltage is applied to the scan electrode by turning on the third switch coupled between the voltage converter and the scan electrode in a state in which the second switch is turned off.

16. The driving method of claim 15, wherein a rising ramp pulse, having a slope for a rising period of the reset period generated by a ramp generator connected to the third switch, is applied to the scan electrode.

17. The driving method of claim 16, wherein the variable voltage is obtained by controlling the first and second resistors of the voltage converter, including a transistor having a first terminal coupled to the power supply and a second terminal coupled to the third switch, a first resistor having a first terminal coupled to the power supply and a second terminal coupled to a third terminal of the transistor, and a second resistor having a first terminal coupled to the third terminal of the transistor and a second terminal coupled to the third switch.

18. The driving method of claim 11, further comprising applying a display data signal from the address driver to the address electrode, and applying a sustain pulse from the sustain electrode driver to the sustain electrode.
